(19) United States
(12) Patent Application Publication
(10) Pub. No.: US 2022/0369445 A1
(43) Pub. Date: Nov. 17, 2022

(54) IOT Device and System

(71) Applicant: Equans Holding UK Limited, Tyne and Wear (GB)

(72) Inventors: Mark Davenport, Tyne and Wear (GB); Raul Hernandez Aquino, Tyne and Wear (GB)

(21) Appl. No.: 17/776,517

(22) PCT Filed: Nov. 13, 2020
(86) PCT No.: PCT/GB2020/052903

§ 371 Date: May 12, 2022

(30) Foreign Application Priority Data
Nov. 14, 2019 (GB) 1916554.7

(51) Int. Cl. H05B 47/19; H04L 12/28; G16Y 10/80; G16Y 40/35; G16Y 20/10; H05B 47/18; H05B 47/13; H05B 47/11; H05B 47/185

(52) U.S. Cl. CPC H05B 47/19; H04L 12/2836; G16Y 10/80; G16Y 40/35; G16Y 20/10; H05B 47/18; H05B 47/13; H05B 47/11; H05B 47/185

(57) ABSTRACT

An internet-of-things, IoT, device (100) includes a luminosity sensing unit and a motion sensing unit. The IoT device (100) also includes a first network interface connectable to an IoT coordinator device (200) over a first network using a first network protocol, and a second network interface configured to communicate over a second network via a second network protocol. The IoT device (100) is configured to act as a bridge between the first and second networks, allowing integration of various smart building management services (600). A smart building control system (300) comprises a plurality of the IoT devices (100).

### FIELD

The present application relates to an internet-of-things (IoT) device, particularly an IoT device for use in smart building applications such as controlling luminaires, air conditioning and heating control, energy consumption monitoring, ventilation control, window blind control and access control in a smart building. The present application also relates to a system comprising an IoT device.

### BACKGROUND

There is an increasing demand for IoT solutions in relation to building control. For example, in large commercial buildings, there is a desire to control air conditioning and heating, energy consumption, ventilation, lighting, window blinds, as well as to provide suitable access control to areas of the building. Similar concerns may arise in respect of domestic dwellings, particularly apartment blocks and the like.

To date, the building control solutions offered typically rely on specific technologies, with specific communication protocols and control applications. Accordingly, a building operator may need to acquire and install different gateway devices, bridges and sensors for each of the control solutions. For example, one set of gateways may need to be installed for an air conditioning system, and another for a lighting control system, and yet another for access control. Similarly, the building operator may need to access several software applications to control each of the systems.

Further difficulties arise in the installation of such gateway devices, which may need to be installed in ceiling cavities, walls or floors, often taking significant manpower.

It is an aim of the invention to address the above-mentioned difficulties, and any other difficulties that would be apparent to the skilled reader from the description herein. It is a further aim of the invention to provide an IoT device that is easy to install, and that is usable with a plurality of network protocols and technologies, and which may be used in smart building applications, such as lighting control, air conditioning and heating control, energy consumption monitoring, ventilation control, window blind control and access control.

### SUMMARY

According to the present invention there is provided an apparatus and method as set forth in the appended claims. Other features of the invention will be apparent from the dependent claims, and the description which follows.

According to a first aspect of the disclosure there is provided an internet-of-things, IoT, device, comprising:

a luminosity sensing unit;

a motion sensing unit; and

a first network interface, the first network interface connectable to an IoT coordinator device over a first network using a first network protocol, and

a second network interface, the second network interface configured to communicate over a second network via a second network protocol,

wherein the IoT device is configured to act as a bridge between the first and second networks.

The first network interface may be a wired network interface. The first network interface may be a daisy-chain network interface. The daisy-chain network interface may comprise a first network port configured to receive of data from, and transmit data to, the IoT coordinator device, optionally via other IoT devices preceding the IoT device in a daisy-chain. The daisy-chain network interface may comprise a second network port configured to relay data from the IoT coordinator device to IoT devices succeeding the IoT device in the daisy-chain. The second network port may be configured to receive data from IoT devices succeeding the present IoT device in the daisy-chain for relaying to the IoT coordinator device via the first network port. The IoT device may receive power via the first network interface. The IoT device may supply power to other IoT devices in the daisy-chain via the first network interface.

The first network interface may be a wireless network interface. The first network interface may be a wireless mesh network interface. The first network interface may be a Zigbee® interface.

The IoT device may comprise a modular interface configured to detachably receive an add-on module. The second network interface may comprise a network add-on module attached to the modular interface, suitably a wireless network add-on module. The network add-on module may be an EnOcean® add-on module or wireless mesh network, preferably Zigbee®, add-on module. The add-on module may be a lighting control add-on module. The lighting control add-on module may be a Digital Addressable Lighting Interface, DALI, add-on module, 0-10 v add-on module or a DSI, Digital Serial Interface, add-on module. The add-on module may be a sensor or actuator add-on module. The add-on module may support more than one of the functions listed above. For example, the add-on module may support two or more network technologies.

The IoT device may comprise a housing. The housing may be configured to fit in an aperture formed in a ceiling. The housing may be configured to be retrofitted to an aperture for a passive infrared (PIR) sensor. The housing may comprise a cylindrical body portion and a disc-shaped portion at one end of the cylindrical body portion. The diameter of the disc-shaped portion may be greater than the diameter of the cylindrical body portion, such that a flange is defined at the junction of the disc-shaped portion and cylindrical body portion. The cylindrical body portion may be sized to be received in the aperture, and the diameter of the disc-shaped portion may be sized to be greater than the size of the aperture.

The housing may be configured to be received in a casing of luminaire.

The motion sensing unit may comprise a PIR sensor or a connector for connection to a PIR sensor. The motion sensing unit may comprise a microwave sensor or a connector for connection to a microwave sensor.

The luminosity sensing unit may comprise a broadband photodiode, configured to operate on the visible and infrared light spectrum. The luminosity sensing unit may comprise an infrared-responding photodiode. The luminosity sensing unit may be configured to process the signals received from the photodiodes and calculate a lux level.

The IoT device may comprise a Bluetooth® interface, preferably a Bluetooth® low energy interface.

The IoT device may comprise a lighting interface unit configured to control a luminaire. The lighting interface unit may be a DALI interface unit or 0-10 v interface unit.

The IoT device may comprise a power meter unit configured to monitor power consumed by a luminaire or other device. The power monitor unit may be connected to a mains power supply and the luminaire or other device. The mains power supply may power the IoT device. The power meter unit may compute one or more of peak current, peak voltage, real power, reactive power, apparent power, power factor and RMS voltage and current.

According to a second aspect of the disclosure there is provided a smart building control system comprising a plurality of IoT devices as defined in the first aspect.

The system may comprise a coordinator device connectable to each of the IoT devices, wherein the coordinator device is connectable to a network, preferably the Internet. The system may comprise a control server connected to the network. The system may comprise a plurality of luminaires. The system may comprise a smart building service, connected to the system via the second network interface of one or more of the IoT devices.

Further preferred features of the second aspect may be as defined herein in relation to the first aspect, and may be combined in any combination.

According to a third aspect of the disclosure there is provided a smart building control method, comprising:

transmitting data from an IoT device as defined in the first aspect to an IoT coordinator device; and

transmitting the data from the IoT coordinator device to a network.

Further preferred features of the third aspect may be as defined herein in relation to the first or second aspect, and may be combined in any combination.

### BRIEF DESCRIPTION OF DRAWINGS

For a better understanding of the invention, and to show how examples of the same may be carried into effect, reference will now be made, by way of example only, to the accompanying diagrammatic drawings in which:

FIG. 1 is a perspective view of a first example IoT device;

FIG. 2 is a side view of the first example IoT device of FIG. 1;

FIG. 3 is a top view of the first example IoT device of FIG. 1-2;

FIG. 4 is a perspective view of the first example IoT device of FIG. 1-3 with the housing removed;

FIG. 5 is a perspective view of the first example IoT device of FIG. 1-4 with the housing removed;

FIG. 6 is a schematic block diagram of the first example IoT device of FIG. 1-5;

FIG. 7 is a schematic view of a first example system comprising the first example IoT device of FIG. 1-6;

FIG. 8 is a bottom perspective view of a second example IoT device with the housing removed;

FIG. 9 is a top perspective view of the second example IoT device of FIG. 8;

FIG. 10 is a schematic block diagram of the second example IoT device of FIG. 8-9;

FIG. 11 is a schematic view of a second example system comprising the second example IoT device of FIGS. 8-10; and

FIG. 12 is a schematic flowchart of an example smart building control method.

In the drawings, corresponding reference characters indicate corresponding components. The skilled person will appreciate that elements in the figures are illustrated for simplicity and clarity and have not necessarily been drawn to scale. For example, the dimensions of some of the elements in the figures may be exaggerated relative to other elements to help to improve understanding of various example examples. Also, common but well-understood elements that are useful or necessary in a commercially feasible example are often not depicted in order to facilitate a less obstructed view of these various example examples.

### DESCRIPTION OF EMBODIMENTS

In overview, examples of the disclosure provide an IoT device for use in smart building applications. The example IoT devices act as a universal gateway or “multi-gateway” supporting different wireless and wired networking technologies as well as sensing and control elements. In some examples, the functionality of the device can be expanded to support extra sensors and/or technologies via add on modules. This enables the integration of a wide range of services and applications, without the need for separate networking hardware to control each of the separate services and applications.

For example, the IoT device may be for use in lighting control applications. The IoT device comprises luminosity and motion sensors. In some examples, the IoT device is configured to be retrofitted in place of a standard ceiling tile mounted passive infrared sensor. In other examples, the IoT device is installable in the casing of a luminaire. Accordingly, examples of the disclosure provide an IoT device that can either have an external fitting or integrated within a luminaire. The IoT device may also be for use in controlling luminaires, air conditioning and heating control, energy consumption monitoring, ventilation control, window blind control and access control in a smart building

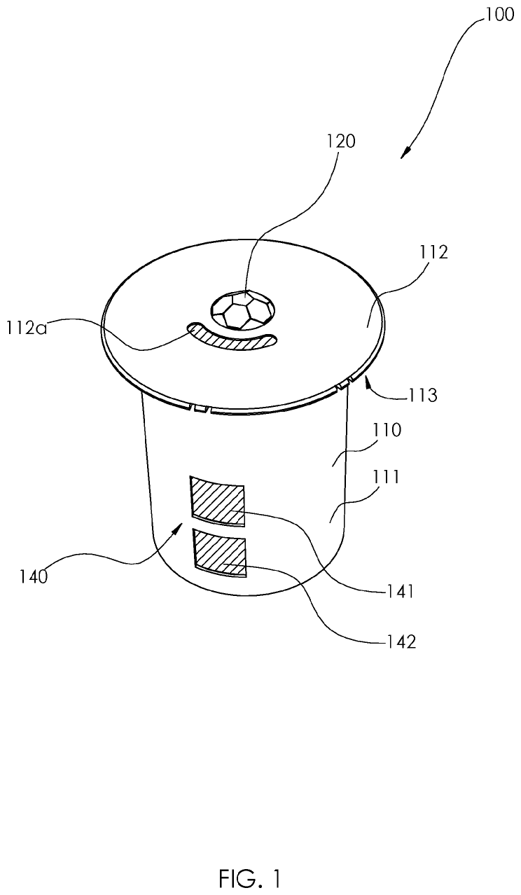

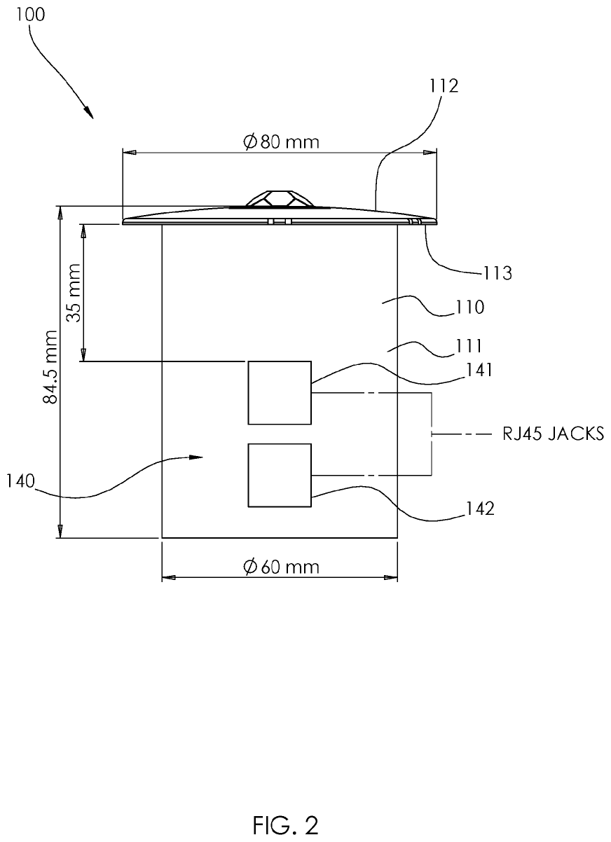

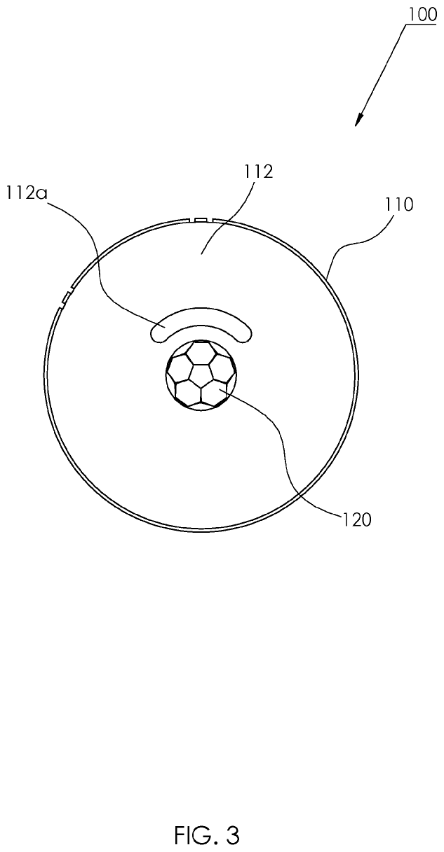

FIG. 1-6 show a first example IoT device 100.

The IoT device 100 comprises a housing 110. The housing 110 comprises a cylindrical body portion 111 and a disc-shaped portion 112 at one end of the cylindrical body portion 111. The diameter of the disc-shaped portion 112 is greater than the diameter of the cylindrical body portion 111, such that a flange 113 is defined at the junction of the disc-shaped portion 112 and cylindrical body portion.

The housing 110 is configured to fit in an aperture in a ceiling (e.g. in a ceiling tile). Particularly, the cylindrical body portion 111 is sized to be received in the aperture, but the diameter of the disc-shaped portion is sized to be greater than the size of the aperture. Accordingly, flange 113 contacts the ceiling around the aperture therein. This results in an optimum placement of the device to provide the best coverage for the wireless technologies used. Furthermore, the IoT device may be straightforwardly retrofitted in place of existing, non-IoT enabled passive infrared (PIR) sensors.

The IoT device 100 comprises a first network interface, generally indicated by the reference numeral 140. The first network interface 140 is configured to communicate via a first network using a first network protocol. The first network interface 140 may also be referred to as a backbone network interface, and the first network referred to as a backbone network. The first network interface 140 is a wired network interface. The first network interface 140 also acts as the power supply for the IoT device 100.

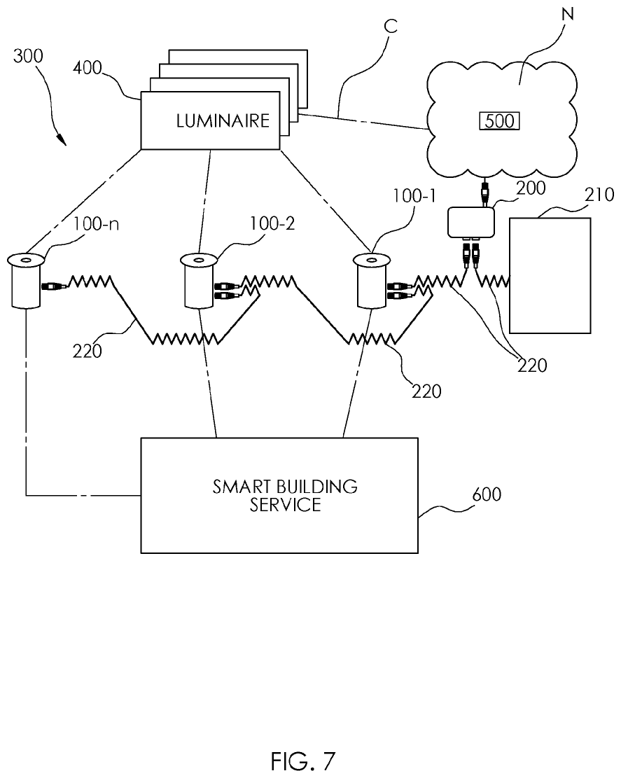

In detail, the first network interface 140 comprises a first network port 141 and a second network port 141. The network ports 141, 142 allow the IoT device to be connected to an IoT coordinator device 200 as part of a daisy-chain network, which will be discussed in more detail later with reference to FIG. 7.

In other words, the first network port 141 is for receipt of data from, and transmission of data to the IoT coordinator device 200, optionally via other IoT devices 100 preceding the present IoT device 100 in the daisy-chain. The second network port 141 is for relaying data from the IoT coordinator device 200 to other IoT devices 100 succeeding the present IoT device 100 in the daisy-chain, and receiving data from the other IoT devices 100 succeeding the present IoT device 100 in the daisy-chain for relaying to the IoT coordinator device 200.

In addition, the first network port 141 is for receipt of power from the IoT coordinator device 200, optionally via other IoT devices preceding the present IoT device 100 in the daisy-chain. The second network port 141 is for transmission of power to other IoT devices 100 succeeding the present IoT device 100 in the daisy-chain.

In one example, the network ports 141, 142 are female RJ45 connectors, configured to receive CAT5 or CAT6 cables having male RJ45 connectors. Two pins of the RJ45 connectors may be for the supply of power (VCC and ground). A further two pins of the RJ45 connectors may be for the supply of data according to the RS-485 standard (i.e. RS-485 A and RS-485 B). In one example, pins are provided for communication according to the DALI (Digital Addressable

Lighting Interface) standard. For example a further pin may be a DALI+ pin, with the ground pin also acting as the DALI− pin.

The IoT device 100 further comprises a modular interface 160, to which add-on modules can be detachably attached. The modular interface 160 may take the form an expansion port 160. In some examples, the IoT device 100 comprises a plurality of expansion ports 160, which may be collectively form a modular interface 160. The expansion port 160 may be configured to receive an add-on module in the form of an expansion board 170.

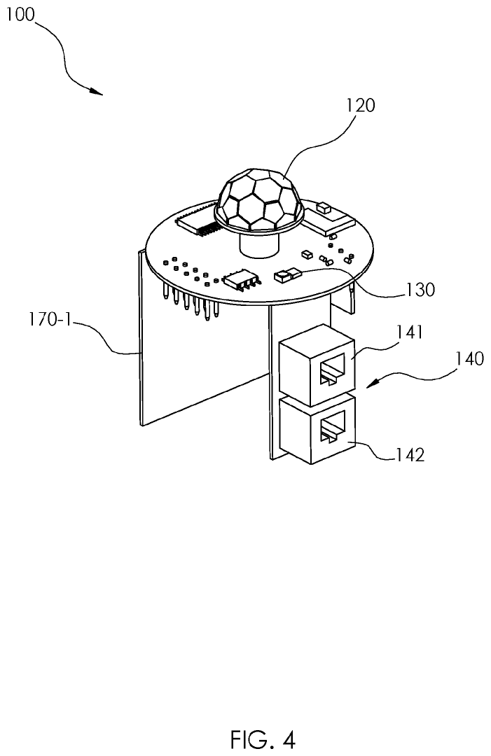

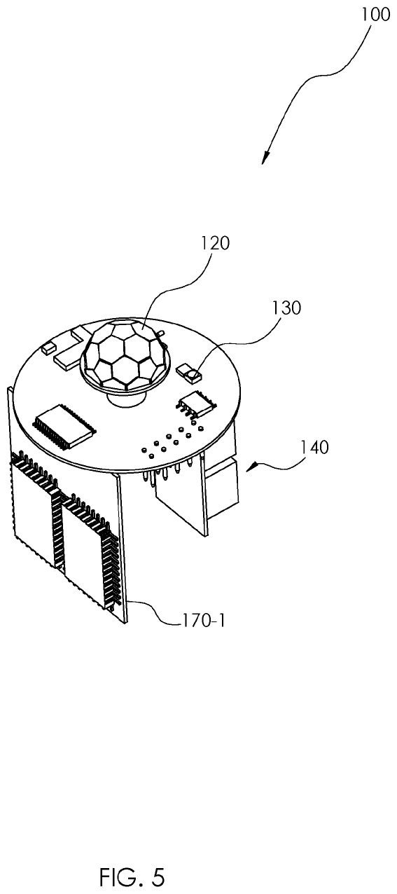

The expansion module or board 170 may be a network interface module 170-1, which provides connectivity according to a network protocol. For example, the network interface board 170-1 may be an EnOcean® module, having an EnOcean® transceiver configured to connect to EnOcean® enabled devices or sensors. FIG. 4-5 show an EnOcean® expansion board 170-1 installed in the IoT device.

In a further example, a Zigbee® network interface module 170-1 may be provided for connection to a Zigbee® network, for example an ad-hoc Zigbee® network. For example, the Zigbee® network may be used to transmit data (e.g. data from the luminosity sensing unit 130 or motion sensing unit 120) instead of or in addition to the first network interface 140. The Zigbee® network interface board 170-1 may also be used to interface with the IoT devices 1100 described herein.

Accordingly, the network interface module 170-1 acts as a second network interface, permitting the device 100 to communicate over a second network, using a second network protocol that may be different to the protocol of the first network. The device 100 may therefore be configured to act as a network bridge between the two networks. In examples where more than one network add-on module 170-1 is attached to the modular interface 160, the device 100 may act as a bridge between each of the networks associated with the respective network add-on modules.

In a further example, the expansion module 170 is a lighting interface module or board 170-2. For example, the expansion module 170-2 is a DALI interface board 170-2, configured to wirelessly control DALI-enabled luminaires. In other examples, the lighting interface board 170-2 is configured to control luminaires according to other lighting control protocols, such as 0-10v or DSI (Digital Serial Interface). In other examples, the expansion board 170 may be a sensor expansion board 170-3, comprising a sensor. The sensor may for example be a CO₂ sensor, temperature sensor or any other sensor.

In further examples, the add-on module may be an actuator module. For example, the add-on module may comprise an actuator to operate a door, window, window blind, smart glass or the like. The actuator module may comprise a relay, solenoid or may output a voltage in order to operate the door, window, window blind, smart glass etc.

The modules 170 may be straightforwardly installed in the IoT device 100, by removing the housing 110 and plugging the expansion board 170 into an expansion port 160, before replacing the housing 110. The firmware 101 may be configured to identify the expansion board 170 that has been plugged in. Accordingly, the IoT device 100 can be readily customised, so as to provide the desired network connectivity and functionality. Accordingly, the device 100 can readily act as a multi-gateway, integrating differing wired or wireless technologies, without the need to install and maintain separate networking hardware for different building control systems.

In addition, the use of such expansion boards 170 provides a degree of future-proofing for the IoT device 100. If a new networking technology or sensor is developed, the IoT device 100 may be retrofitted with a suitable expansion board for the new networking technology (e.g. other wireless mesh networks) or sensor. In such examples, the firmware 101 may be updated to account for the new networking technology or sensor.

In some examples, an expansion board 170 may provide a plurality of functions. For example, an expansion board 170 may provide network connectivity via two or more differing protocols, or provide two or more different sensors.

The IoT device comprises a motion sensing unit 120. The motion sensing unit 120 is disposed at an aperture in the disc-shaped portion 112, for example in the middle of the disc-shaped portion. The motion sensing unit 120 may take the form of a PIR sensor.

The IoT device also comprises a luminosity sensing unit 130. A window 112a is formed in the disc-shaped portion 112, via which the luminosity sensing unit 130 receives light. In one example, the window 112a is a transparent portion of the housing 110 (e.g. a slot) formed in the disc-shaped portion 112. In other examples, the window 112a may be an aperture in the housing 110.

In one example, the luminosity sensing unit 130 comprises a broadband photodiode, configured to operate on both the visible and infrared light spectrum, and an infrared-responding photodiode. The broadband photodiode and infrared-responding photodiode may be mounted on an integrated circuit, configured to provide a near-photopic response over an effective 20-bit dynamic range, thereby providing a 16-bit resolution and a motion detection range of approximately 10m. In one example, the integrated circuit processes the information received from photodiodes and calculates and outputs a lux level. In another example, the IoT device 100 comprises a controller, such as a processor, field-programmable gate array (FPGA), or logic circuit, which calculates and outputs a lux level. The IoT device may comprise firmware 101, for example stored in a memory, comprising instructions which when executed calculate the lux level. The lux level may be calculated using a formula which approximates the human eye response.

The lux calculation is a function of CHO channel count (CODATA, sensitive to visible and infrared light, for example derived from the broadband photodiode), CH1 channel count (C1DATA, sensitive primarily to infrared light, for example derived from the infrared-responding photodiode), the ambient light sensing gain (AGAINx), and the integration time of the analog-digital converter (ADC) in milliseconds (ATIME_ms).

If an aperture, glass/plastic, or a light pipe attenuates the light equally across the spectrum (300 nm to 1100 nm), then a scaling factor referred to as glass attenuation (GA) can be used to compensate for attenuation. Fora device in open air with no aperture or glass/plastic attenuating the light entering the luminosity sensing unit 130, GA=1. Counts per Lux (CPL) needs to be calculated initially as well.

Under these conditions, the light level can be calculated as:

CPL=(ATIME_ms×AGAINx)/(GA×53)

Lux1=(CODATA−2×C1DATA)/CPL

Lux2=(0.6×CODATA−C1DATA)/CPL

Lux=max(Lux1,Lux2)

The first segment of the equation (Lux1) covers fluorescent and incandescent light. The second segment (Lux2) covers dimmed incandescent light.

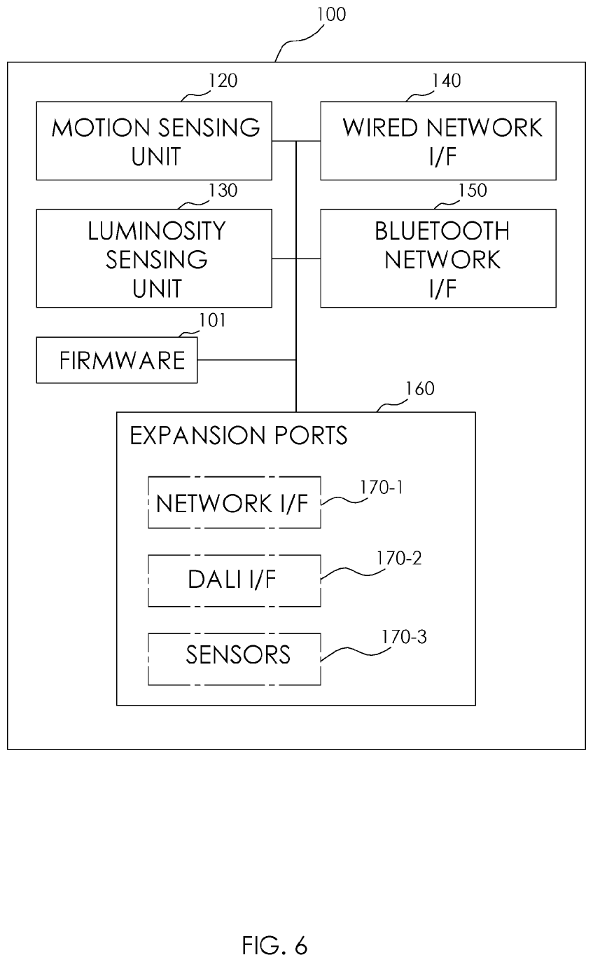

As shown in FIG. 6, the IoT device 100 further comprises a Bluetooth® interface 150. The Bluetooth® interface 150 may be a Bluetooth® Low Energy (BLE) interface 150. The BLE interface 150 can transmit to proximate BLE-enabled devices, thereby acting as a beacon. The BLE transmission feature allows users to make use of their smartphones or other smart devices to detect the presence of the nearby BLE interface 150 installed in the IoT device 100, and interact with location-based services and infrastructure. On the other hand, the BLE interface 150 may additionally or alternatively scan for proximate BLE beacons. The scanning feature allows visitors and other external users to be detected and positioned within the building, enabling other services such as access control, heating and lighting control and so on.

FIG. 7 illustrates a system 300 comprising a plurality of IoT devices 100-1 to 100-n, an IoT coordinator device 200, a power supply 210, and a plurality of luminaires 400.

The plurality of IoT devices 100-1 to 100-n are serially connected in a daisy-chain network via cables 220. One end of the daisy-chain is connected to the IoT coordinator device 200. The IoT coordinator device 200 is also connected to the power supply 210. In one example, the power supply is a 7-36V DC power supply, connected to the IoT coordinator device 200 via a CAT5 or CAT6 cable 220. The IoT coordinator device 200 distributes power to the IoT devices 100 as discussed above.

The IoT coordinator device 200 is further connected to a network N. The network N may be a Local Area Network (LAN), Wide Area Network (WAN) or any other network. For example, the network N may be the Internet or an intranet. Accordingly, connectivity is provided between the IoT devices 100 and a control server 500. The control server 500 may host one or more applications for smart building control.

The luminaires 400 are furthermore connected to the system 300, such that their output can be modified based upon data (e.g. motion sensor data from the motion sensing unit 120 or lux level data from the luminosity sensing unit 130) received from the IoT devices 100. In some examples, the luminaires 400 are connected to proximate IoT devices 100. For instance, the luminaires 400 may be wirelessly controlled via the IoT devices 100. For example, the IoT devices 100 may include a lighting control interface 170-2 which may communicate with the luminaires 400. In other examples, the luminaires 400 are connected to the network N via another wired or wireless communication link C.

In other examples, the data received from the IoT devices 100-1 to 100-n may be used to control other building services, such as heating, air-conditioning, access control and so on.

As discussed above, the IoT devices 100-1 to 100-n act as network bridges between the network comprising IoT coordinator device 200 and other networks such as those upon which other smart building services operate, via the second network interface. For example, as shown in FIG. 7, each of the IoT devices 100-1 to 100-n are also in communication with a smart building service 600 via their second network interface. The smart building service 600 may for example be a lighting control system, an access control system, heating or air conditioning system, ventilation control system, window blind control system or the like.

Accordingly, the control server 500 may control the other building services, such as service 600, by communicating via the IoT co-ordinator and one or more of IoT devices 100-1 to 100-n, thereby integrating the services. For example, if the building service 600 is a lighting service, the control server 500 may control the lighting of the building in this manner. Likewise, if the building service 600 is an access control system, heating or air conditioning system, ventilation control system, window blind control system, the control server 500 may control access to the building, control the air conditioning or heating, ventilation or window blinds.

Whilst FIG. 7 illustrates that each of the IoT devices 100-1 to 100-n are in communication with the smart building service 600 via their respective second network interfaces, it will be appreciated that either only one or a subset of the IoT devices 100-1 to 100-n may be in communication with the smart building service 600. Furthermore, the IoT devices 100-1 to 100-n may connect to a plurality of building services 600 in the above-described manner.

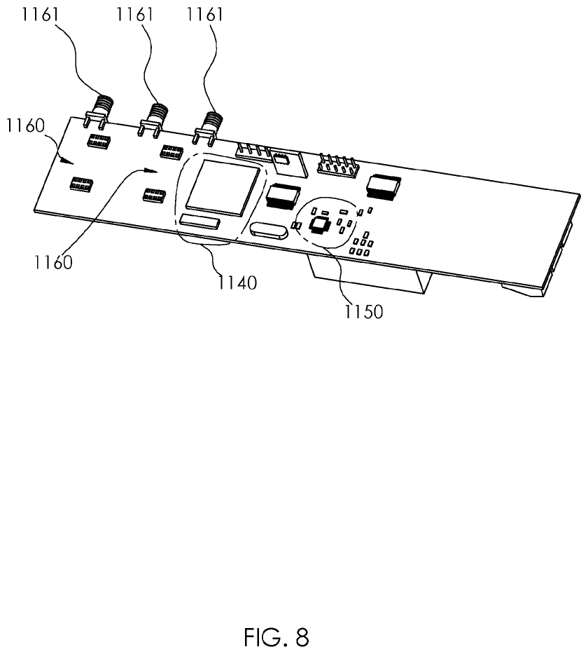

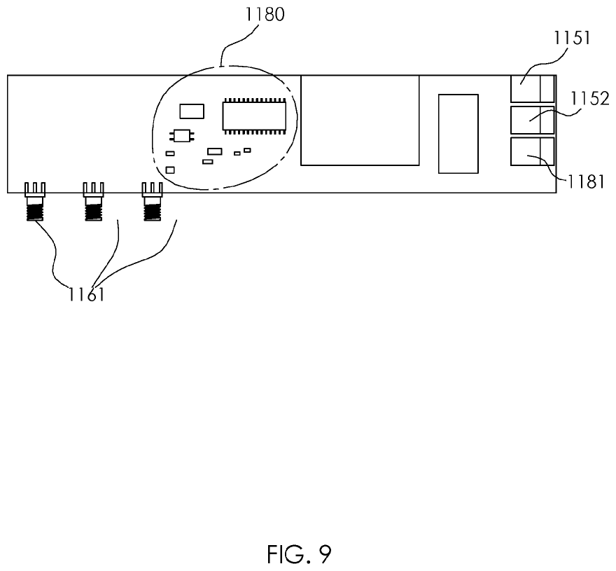

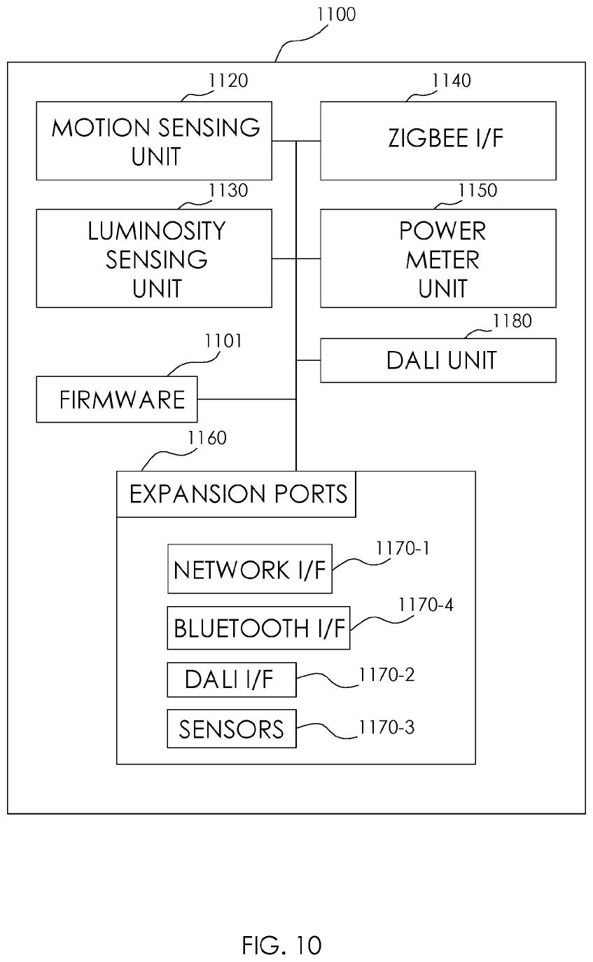

Turning now to FIG. 8-10, a second example IoT device 1100 is shown. Elements of the example IoT device 1100 corresponding to elements of the example IoT device 100 have the same reference numerals, incremented by 1000.

The second example IoT device 1100 takes the form of elongate board having a housing (not shown). The IoT device 1100 is configured for installation within a light fitting. In other words, the IoT device 1100 is sized to be received in a cavity found within a standard office building light fitting.

The IoT device 1100 comprises a motion sensing unit 1120. However, in contrast to IoT device 100, the motion sensing unit 1120 takes the form of a connector and associated circuitry, attachable via a cable to a motion sensor disposed remote from the IoT device 1100.

For example, the motion sensing unit 1120 may comprise a connector for connection to a PIR sensor. The PIR sensor finds particular utility for metallic light fittings with little to no signal absorbent material, such that the PIR sensor needs to be exposed from the casing of the light fitting. In other examples, a microwave sensor is employed. The microwave sensor finds particular utility in non-metallic light fittings, or fittings where enough signal absorbent material is present to allow the microwave sensor to be disposed within the casing of the light fitting.

The IoT device 1100 also comprises a luminosity sensing unit 1130. However, in contrast to IoT device 100, the luminosity sensing unit 1130 takes the form of a connector and associated circuitry, attachable via a cable to a luminosity sensor disposed remote from the IoT device 1100. The luminosity sensor may be substantially as disclosed in relation to luminosity sensing unit 130 of IoT device 100.

In contrast to the IoT device 100, the IoT device 1100 comprises a built-in wireless network interface 1140. The wireless network interface 1140 may for example be a Zigbee interface for connection to an IoT coordinator device 1200 via a Zigbee mesh network formed from a plurality of devices 1100. The wireless network interface 1140 acts as the first, or backbone, network interface.

The IoT device 1100 additionally comprises a power meter unit 1150, configured to monitor the power consumed by the luminaire to which it is installed. In more detail, the device 1100 comprises a first connector 1151 for receipt of mains power. The mains power may be used to power the IoT device 1100. The device 1100 also comprises a second connector 1152 for connection to the luminaire. Accordingly, power supplied to the luminaire is routed through the IoT device 1100. The power meter unit 1150 monitors the supplied power, and comprises an energy measurement integrated circuit which incorporates 4^{th} order Delta-Sigma analog-to-digital converters arranged to compute diverse power measurements such as peak current, peak voltage, real power, reactive power, apparent power, power factor and RMS voltage and current. This allows not only to monitor the instantaneous power consumed by the light fitting but also to verify its health and correct operation. In other examples, the power meter unit 1150 may be utilised to monitor power consumption of a device other than the luminaire, instead of or in addition to monitoring the power consumed by the luminaire. The power meter unit 1150 may accordingly comprise a power interface for connection to a device other than the luminaire.

The IoT device 1100 further comprises a lighting control unit 1180, for example a DALI unit configured to control the luminaire based on signals received by the IoT device 1100. For example, the DALI unit 1180 comprises a connector 1181 connectable to a corresponding DALI port provided on the luminaire. The DALI unit 1180 further comprises suitable circuitry and/or control logic for controlling the luminaire based on the received signals. In other examples, the IoT device 1100 may additionally or alternatively comprise a lighting control unit 1180 which uses another lighting control protocol, such as 0-10v or DSI. In further examples, the lighting control unit 1180 may employ a relay and/or other circuitry to control non-dimmable luminaires, or to provide on/off control to the luminaires connected to the relay. In still further examples, the relay and/or other circuitry may be used to control other devices. In such examples, the relay and/or other circuitry may form a separate unit to the lighting control unit 1180.

The IoT device 1100 further comprises a modular interface (e.g. expansion ports) 1160 to receive add-on modules 1170. The add-on modules 1170 may be substantially as discussed above in relation to IoT device 100. In addition, the add-on modules 1170 may comprise a Bluetooth® expansion board 1170-4, configured to provide Bluetooth® connectivity similar to that provided by Bluetooth® network interface 150 of IoT device 100.

The IoT device 1100 further comprises antennae connectors 1161. If the expansion boards 1170 or the Zigbee interface 1140 requires an external antenna (e.g. because of the nature of the housing of the luminaire), the external antenna may be attached to one of the antennae connectors.

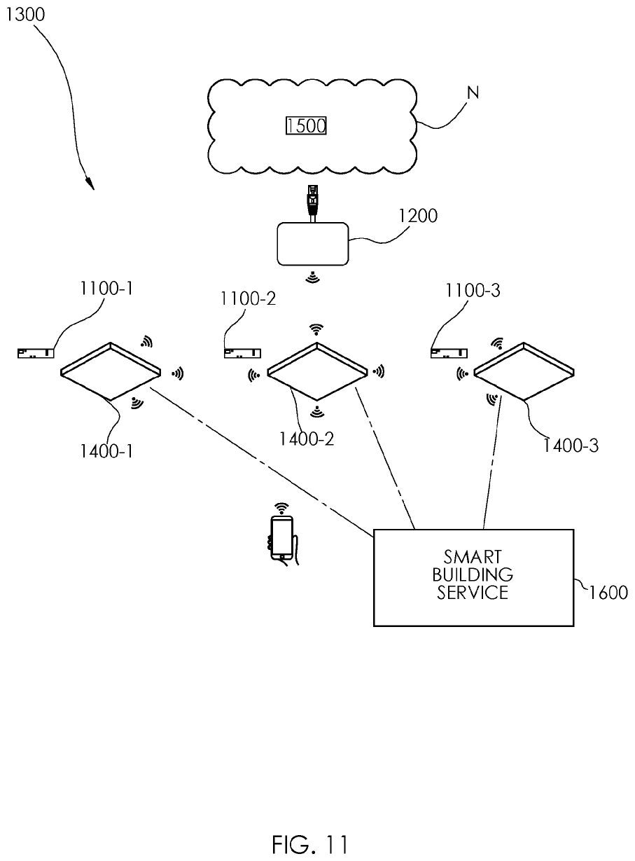

FIG. 11 illustrates a system 1300 comprising a plurality of IoT devices 1100-1 to 1100-3, an IoT coordinator device 1200, and a plurality of luminaires 1400-1 to 1400-3. The plurality of IoT devices 1100-1 to 1100-3 are each installed in a respective luminaire 1400-1 to 1400-3.

The IoT devices 1100 connect to form a mesh communication network. The mesh communication network also comprises the IoT coordinator device 1200. Accordingly, each of the IoT devices 1100 may communicate wirelessly, either directly or indirectly, with the IoT coordinator 1200.

The IoT coordinator device 1200 is further connected to a network N. The network N may be a Local Area Network (LAN), Wide Area Network (WAN) or any other network. For example, the network N may be the Internet or an intranet. Accordingly, connectivity is provided between the IoT devices 1100 and a control server 1500. The control server 1500 may host one or more applications for smart building control.

The IoT devices 1100 are configured to transmit and receive data to the network N via the coordinator 200. Accordingly, the luminaires 1400 can be controlled based upon data (e.g. motion sensor data from the motion sensing unit 1120 or lux level data from the luminosity sensing unit 1130) received from the IoT devices 1100. In addition, data received from the IoT devices. In other examples, the data received from the IoT devices 1100-1 to 1100-n may be used to control other building services, such as heating, air-conditioning, access control and so on.

Furthermore, in a similar manner as discussed above with respect to FIG. 7, the IoT devices 1100-1 to 1100-n are connected via their second network interfaces to a smart building service 1600. Accordingly, the devices 1100-1 to 1100-n act as a multi-gateway, integrating the devices with other services.

It will be appreciated that the features of IoT devices 100 and 1100 may be combined in any combination.

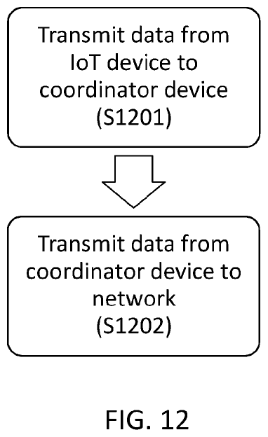

FIG. 12. Illustrates an example smart building control method. The method comprises block S1201, in which data is transmitted by an IoT device 100 or 1100. The data may be motion sensor data, lux level data, sensor data, power consumption data, Bluetooth® beacon data, or any other data captured by the IoT devices 100 or 1100 as discussed herein.

The method comprises block S1202, in which the transmitted data is received by the coordinator device 200 or 1200 and transmitted to the network N.

The above-described devices, systems and methods advantageously provide smart connectivity as part of lighting infrastructure. Lighting is a necessity in any building, and therefore the infrastructure for lighting is advantageously always present. The above-described devices provide for ease of installation, either as a retrofit in place of existing PIR sensors or in the enclosures of light fittings. The data captured by these devices, such as motion sensor data and luminosity data, can be used in a variety of manners to control various smart building system. Whilst the devices may have particular utility in lighting control, it will be appreciated that they may be employed in a variety of smart building applications, such as heating and access control.

The above-described devices, systems and methods conveniently provide a bridge between networks. This allows for easy integration of different smart building management systems.

In addition, the above-described devices are modular, allowing for the selection and addition of modules to provide desired connectivity and sensing capability. This also permits the future addition of modules to provide connectivity according to newly emerging technology.

At least some of the examples described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some examples, the described elements may be configured to reside on a tangible, persistent, addressable storage medium and may be configured to execute on one or more processors. These functional elements may in some examples include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example examples have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example may be combined with features of any other example, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A smart building control system, comprising:
a plurality of an internet-of-things, IoT, devices;
an IoT coordinator device connectable to a control server over an external network; wherein each IoT device comprises:
a luminosity sensing unit;
a motion sensing unit; and
a first network interface, the first network interface connectable to the IoT coordinator device over a first network using a first network protocol, and
a second network interface, the second network interface configured to communicate with a smart building service over a second network on which the smart building service operates via a second network protocol,
wherein the IoT device is configured to act as a bridge between the first and second networks to allow the control server to control the smart building service.

2. The system of claim 1, wherein the first network interface is a wired network interface.

3. The system of claim 2, wherein the IoT device is configured to receive power via the wired network interface.

4. The system of claim 2, wherein the wired network interface is a daisy-chain network interface.

5. The system of claim 4, wherein the IoT device is configured to supply power to other IoT devices in the daisy-chain via the wired network interface.

6. The system of claim 1, wherein the first network interface is a wireless mesh network interface.

7. The system of claim 1, wherein the IoT device comprises: a modular interface configured to detachably receive an add-on module.

8. The system of claim 7, wherein the second network interface comprises a network add-on module attached to the modular interface.

9. The system of claim 8, wherein the modular interface is configured to receive one or more of a lighting control module, a sensor module, or an actuator module.

10. The system of claim 1, wherein the IoT device comprises a housing configured to fit in an aperture formed in a ceiling.

11. The system of claim 10, wherein the housing is configured to be retrofitted to an aperture for a passive infrared (PIR) sensor.

12. The system of claim 10, wherein the housing is configured to be received in a casing of a luminaire.

13. The system of claim 1, wherein the motion sensing unit comprises a passive infrared, PIR, sensor or a connector for connection to a PIR sensor.

14. The system of claim 1, wherein the motion sensing unit comprises a microwave sensor or a connector for connection to a microwave sensor.

15. The system of claim 1, wherein the luminosity sensing unit comprises:
a broadband photodiode, configured to operate on the visible and infrared light spectrum, and an infrared-responding photodiode,
wherein the luminosity sensing unit is configured to process the signals received from the photodiodes and calculate a lux level.

16. The system of claim 1, comprising a Bluetooth® low energy interface.

17. The system of claim 1, comprising a lighting interface unit configured to control a luminaire.

18. The system of claim 1, wherein the IoT device comprises a power meter unit configured to monitor power consumed by a luminaire.

19. The system of claim 18, wherein the power monitor unit is connected to a mains power supply and the luminaire, and the IoT device is configured to receive power from the mains power supply.

20. The system of claim 18, wherein the power meter unit is configured to compute one or more of peak current, peak voltage, real power, reactive power, apparent power, power factor and RMS voltage and current.

21. (canceled)

22. (canceled)

23. (canceled)

24. The system of claim 1, comprising a plurality of luminaires.

25. A smart building control method of the system of claim 1, comprising:
transmitting data from an IoT device of the plurality of IoT devices to the IoT coordinator device;
transmitting the data from the IoT coordinator device to the control server over the external network; and
controlling, by the control server, the smart building service by communicating with the smart building service via the IoT coordinator device and the IoT device.
